(19) United States
(12) Patent Application Publication
(10) Pub. No.: US 2016/0302543 A1
(43) Pub. Date: Oct. 20, 2016

(54) APPARATUS, SYSTEM AND METHOD OF PROVIDING FOR THE USE OF A STYLUS

(71) Applicant: Robert G. Petit, St. Petersburg, FL (US)

(72) Inventor: Robert G. Petit, St. Petersburg, FL (US)

(73) Assignee: JABIL CIRCUIT, INC., St. Petersburg, FL (US)

(21) Appl. No.: 14/690,257

(22) Filed: Apr. 17, 2015

(51) Int. Cl. A45C 11/34; B29C 45/14; A45C 13/02

(52) U.S. Cl. CPC A45C 11/34; A45C 13/02; B29C 45/14598; B29L 2023/00

(57) ABSTRACT

The disclosure includes an apparatus, system and method of providing a stylus receiving tool. The apparatus, system and method may include a body portion having an anterior end, a posterior end opposite the anterior end, an exterior portion and an interior portion each extending from the anterior end to the posterior end; and a receiver suitable for receiving a stylus, formed within the interior portion, and having an open portion at the anterior end.

### CROSS-REFERENCE TO RELATED APPLICATIONS

N/A

### BACKGROUND

1. Field of the Disclosure

The present disclosure relates to mobile device input, and, more particularly, to an apparatus, system and method for providing for the use of a stylus.

2. Background of the Disclosure

Upon initial release in the early 2000s, many personal digital assistants (PDAs) included therewith a stylus to allow the PDA user to “write” on, or enter information or instructions to, the PDA. Although the functionality and capabilities of more modern smartphones, tablet computers, touchscreen laptops, and the like have increased many-fold since the advent of the PDA in the early 2000s, these modern devices nevertheless still frequently include a stylus to allow the user to “write” on the screen of the device, whereupon the “written” input is captured by the device electronically, such as for conversion to text, a drawing capture, a keystroke or similar instruction, or the like.

However, a stylus is frequently relatively small in diameter, and hence is difficult to hold for inexperienced users, the elderly, those with various conditions such as arthritis, and the like. Moreover, even for experienced users the small diameter of a stylus may make it difficult to draw, write, or create, and may cause discomfort for the user due to the increased pressure applied between the user's fingers to handle and operate the stylus because of its small diameter. These difficulties arise particularly in the case of power users, that is, those users that very frequently use the stylus of their modern device to draw, write, or create. All users, and particularly power users, may suffer the aforementioned discomfort due to the use of a stylus over longer periods of time, and/or with increased frequency.

Efforts have been undertaken to address the foregoing difficulties in the use of the modern stylus by providing so called “aftermarket” styluses. These aftermarket styluses may be larger and more comfortable for the user to use, particularly over longer use periods. However, the aftermarket nature of such styluses may cause operability issues, such as wherein the tip of the stylus does not operate with the screen of the device in as convenient a manner as would the device's native stylus, or, worse yet, wherein the incompatability of the aftermarket stylus with the device causes damage to the device.

Further, such aftermarket styluses, because they frequently differ from the ergonomic design of a native stylus, may be inoperable for placement in the storage location that is intended for the native stylus. For example, a tablet cover for a particular brand of tablet, such as the Samsung Note tablet, may also include within or upon the tablet cover a location for storage of the stylus native to the tablet. If the aftermarket stylus does not mate with such a storage location, the stylus must be stored independently in a location readily available to the user. However, the unique size of an aftermarket stylus may cause storage locations for other devices, such as pens, pencils, and the like, to likewise be unusable for storage of the aftermarket stylus.

Therefore, the need exists for an apparatus, system, and method of providing for the use of a stylus that maybe conveniently stored by the user, that may provide enhanced comfort during use for the user, and that may conveniently operate in the same manner on a device as would a native stylus.

### SUMMARY OF THE DISCLOSURE

The disclosure includes an apparatus, system and method of providing a stylus receiving tool. The apparatus, system and method may include a body portion having an anterior end, a posterior end opposite the anterior end, an exterior portion and an interior portion each extending from the anterior end to the posterior end; and-a receiver suitable for receiving a stylus, formed within the interior portion, and having an open portion at the anterior end.

The method of providing a stylus receiving tool having a body portion with an anterior end, a posterior end opposite the anterior end, an exterior portion and an interior portion each extending from the anterior end to the posterior end, and a receiver suitable for receiving a stylus, formed within the interior portion, and having an open portion at the anterior end, the method may include injection molding a body portion having the receiver therewithin; and second injection molding at least one feature on the exterior portion.

Accordingly, the disclosure provides an apparatus, system, and method of providing for the use of a stylus that maybe conveniently stored by the user, that may provide enhanced comfort during use for the user, and that may conveniently operate in the same manner on a device as would a native stylus.

### BRIEF DESCRIPTION OF THE FIGURES

Understanding of the present disclosure will be facilitated by consideration of the following detailed description taken in conjunction with the accompanying drawings, in which like numerals refer to like parts, and wherein:

FIG. 1 is an illustration of an exemplary receiving tool for receipt of a stylus;

FIG. 2 is an illustration of an exemplary receiving tool for receipt of a stylus; and

FIG. 3 is a flow diagram illustrating an exemplary method of providing a receiving tool for a stylus.

### DETAILED DESCRIPTION OF THE EMBODIMENTS

It is to be understood that the figures and descriptions of the present disclosure have been simplified to illustrate elements that are relevant for a clear understanding of the disclosed exemplary embodiments, while eliminating, for the purpose of clarity, many other elements found in typical similar apparatuses, systems, and processes. Those of ordinary skill in the art may thus recognize that other elements and/or steps are desirable and/or required in implementing the examples of the present disclosure. However, because such elements and steps are well known in the art, and because they do not facilitate a better understanding of the disclosure, a discussion of such elements and steps is not provided herein. The disclosure herein is nevertheless directed to all such variations and modifications to such elements and methods known to those skilled in the art.

The disclosure provides a pen shaped tool suitable for receiving therein of a device stylus. The pen shaped tool may be sized and shaped in the manner of a highly ergonomic standard pen, to thereby increase user comfort during use, and to thereby readily provide for storage of the tool, and/or of the stylus within the tool, in the same manner as a user may store pens and pencils.

The disclosed apparatus, system and method maybe used with any device that provides for the use therewith of a native stylus, such as, but not limited to, tablet computers, smartphones, touchscreen devices, gaming devices, PDAs, and the like. The pen shaped tool may have therein an internal cavity, which cavity may be sized and shaped according to the native stylus to be received therein. Additionally and alternatively, the cavity may provide therein modifiable aspects, such as twist to insert tabs, rubberized pressure nubs, or the like, that may allow for variations in the sizes of styluses suitable to be received within the cavity.

Accordingly, the disclosed exemplary embodiments may increase user comfort, such as by providing less cramping of a user's hand and fingers from holding a smaller, nonstandard shaped writing tool. Further, the disclosed embodiments may provide enhanced control for the user when writing, drawing, creating or instructing using the stylus on the device screen. Yet further, the disclosed embodiments allow for enhanced comfort in the use of native styluses with a given device, thereby enhancing compatibility and decreasing concern that damage may occur from an aftermarket product that is not fully compatible with a given device.

Moreover, the disclosed embodiments may allow for storage of the stylus either within the pen shaped tool, and correspondingly with other pens and pencils, or within the native device upon removal of the native stylus from the pen shaped tool. Because the cavity of the pen shaped tool maybe uniquely designed for the native stylus of a particular device, or may include modifiable features to allow for the use of styluses from various devices, the pen shaped tool may accommodate functions beyond simply writing with the stylus, such as by providing user access to function buttons on the stylus, and the like.

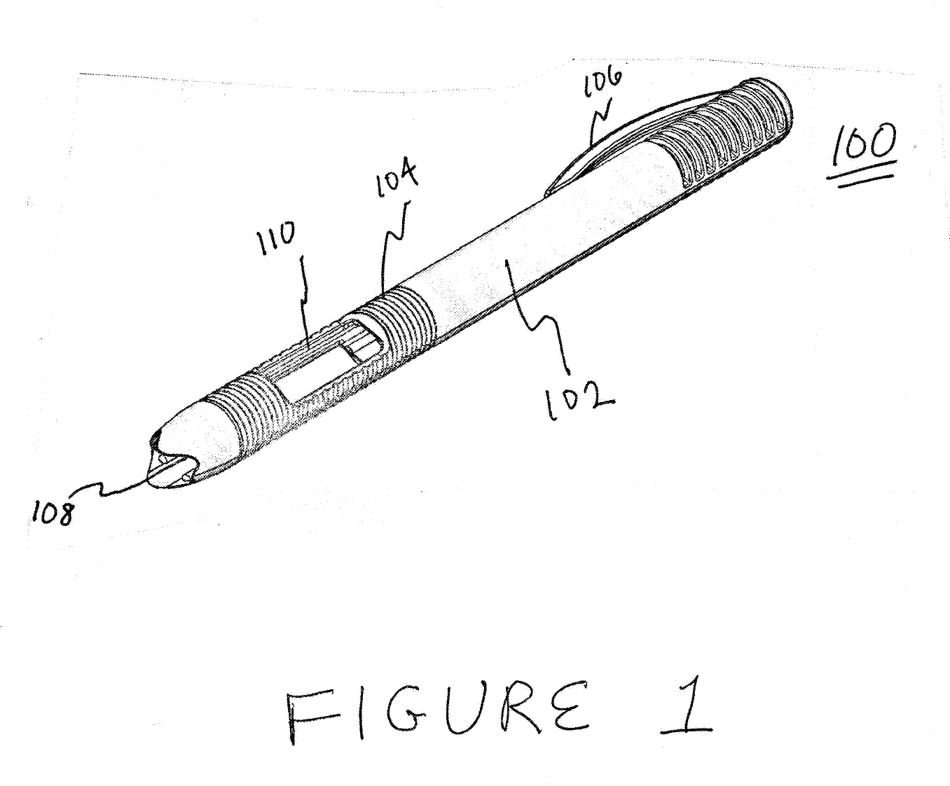

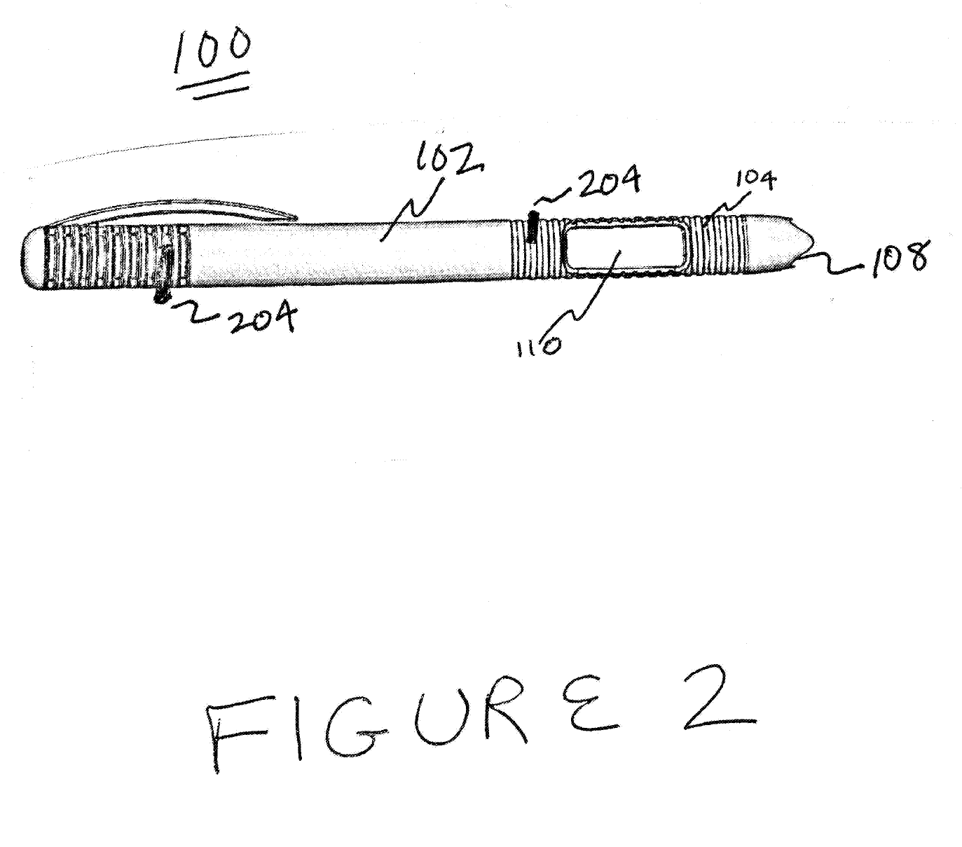

FIGS. 1 and 2 illustrate with particularity an exemplary embodiment of the disclosed stylus receiving tool. As is evident in FIG. 1, the pen shaped tool 100 maybe sized and shaped along its exterior 102 in the manner of a standard pen. As such, the exterior 102 may include a variety of grips, a pen clip, or the like, by way of non-limiting example.

The exemplary pen shaped tool includes therein a receiver 108, such as a cavity, suitable for receiving a device stylus. The pen shaped tool may additionally include secondary features, such as function button actuation receiver 110, that allow for the user to engage particular aspects of a native stylus not common to all styluses, and/or modifiers 204 for the size of cavity 108 to allow for variability in the shapes or sizes of native styluses that maybe received within cavity 108.

As illustrated, the exterior of the tool may be shaped in the manner of a standard pen, and hence the tool may be used subject to the same feeling and usability as would be a standard pen upon insertion of a stylus therewithin. Correspondingly, users who engage in extensive writing, drawing, creating, instructing, or the like using the stylus may experience enhanced comfort in the use. Further, the tool provides the user the ability to use a native stylus, but in a tool that provides enhanced comfort to the user, thereby alleviating the possibility of damage or poor functionality by an after-market stylus to a native device that is not compatible with the after-market stylus.

The disclosed exemplary tool 100 may be portable, and may be stored in the same manner and location as would be a standard pen, such as in a pen holder, pocket protector, brief case, a pen and pencil bag, a purse, or the like. Additionally, the tool 100 may be stored with the stylus resident therein, or the stylus may be removed and stored in a dedicated location for the native stylus, such as on-board a particular device.

The user may actuate the exemplary tool of FIG. 1 by simply pushing the stylus into the tool from the open portion of receiving cavity 108. Those skilled in the art will appreciate in light of the discussion herein that the opening of cavity 108 may be provided at the anterior end of tool 100, that is, at the writing end for the stylus received into the tool, at the posterior end of tool 100, or at both locations. As is illustrated with greater particularity in the exemplary embodiment of FIG. 2 and as referenced above, upon insertion of the stylus into cavity 108, modifiable aspects 204 may be provided on the tool 100, such as to allow for modification of the size of at least portions of receiver 108.

In the illustration of FIG. 2, the modifiable aspects are shown as actuatable rollers, wherein, upon rotation of one or more of the rollers 204, a tab is extended through a hole in the exterior 102 of tool 100 into cavity 108, thereby decreasing the size of cavity 108 at the portion of the cavity immediately below roller 204. Such rollers may, by way of non-limiting example, be spring loaded so as to enhance the frictional engagement of the tab with an inserted stylus. Correspondingly, the tool may be adapted by actuation of roller 204 to receive various stylus shapes and sizes. That is, the tool 100 of FIG. 2 may be substantially universal as to the styluses that may be used therewith.

Of course, those skilled in the art will appreciate, in light of the discussion herein, that various modifiable aspects 204 may be provided to modify the diameter, circumference, or the like, of cavity 108 along various portions thereof. For example, rubberized nubs or tabs may be provided within cavity 108 that extend down into the mouth of cavity 108 but that may be responsive to user pressure in pushing a stylus into cavity 108. Thus, larger styluses may require increased pressure to be exerted by the user to allow for insertion into cavity 108, while smaller diameter styluses may require less pressure to be exerted by the user for insertion into cavity 108.

The disclosed tool may be formed, for example, using injection molding. The injection molding may employ a single-shot mold, or, for example, may employ a two-shot mold, such as wherein rubberized grip aspects are provided to the tool. As such, the tool may be formed of plastic, rubberized plastic, rubber, or the like. By way of non-limiting example, the tool may be formed of recyclable polycarbonate, an acrylic, a styrene, or the like. It may be preferred that at least the cavity 108 portion of tool 100 be formed of a low-friction component, nonstick substance, or at least partially formed of such a nonstick substance, to readily allow for insertion therewithin of a stylus. Of course, portions of cavity 108, such as the stylus-receiving pressure nubs discussed herein above, may be formed of more highly frictional surfaces.

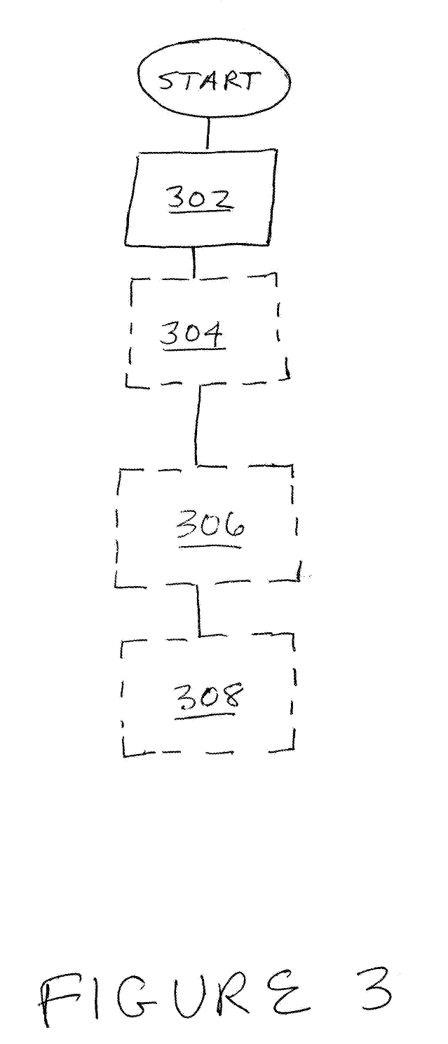

FIG. 3 is a flow diagram illustrating a method 300 of providing tool 100. In the exemplary method, at step 302 a first shot injection mold is used to form a pen shape, such as of a polycarbonate, having substantially centered therein an at least partially hollowed receiver, such as a receiving cavity. A second shot injection mold may be optionally used at step 304 to form at least one feature, such as a rubberized grip, on the pen shape. The injection molding of the feature may optionally comprise providing a function button actuation receiver extending from the exterior portion through to the interior portion.

At optional step 306, a modifiable aspect may be added to the pen shaped tool formed at step 302, such as by a mechanical attachment or insertion, or as a secondary stage of step 302, or as part of optional step 304. Such modifiable aspects may include, by way of non-limiting example, one or more roller actuators extending into the receiving cavity of the interior portion, a pressure nub within the receiving cavity, or the like.

Yet further, at optional step 308, aspects may be added to the exterior of the pen shaped tool. Exterior additions may be, by way of non-limiting example, a pen clip.

Of course, those skilled in the pertinent arts will appreciate, in light of the discussion herein, that known formation processes other than injection molding may be used, such as, by way of non-limiting example, machining or the like. Moreover, and as referenced above, the pen shaped tool may be formed of, for example, a polymer such as the polycarbonate discussed with respect to FIG. 3, acrylic, styrene, or the like, or may be formed of steel, aluminum, or other materials, such as for higher-end tool products.

The exemplary embodiments disclosed may allow for various modification or variations to tool 100. For example, a pen clip may be provided along exterior 102 to allow for storage or locating of the tool in the same manner as one would store or locate a pen. Additionally, the tool 100 may be provided with additional space within cavity 108, or proximate to cavity 108, such as to provide storage space within the rear tip of the tool. For example, recyclable silicon tips for a stylus may be stored within such a space. Moreover, pen-like features, such as a retractable writing utensil, may be included within the body of tool 100, such as alongside cavity 108.

The previous description of the disclosure is provided to enable any person skilled in the art to make or use the disclosed aspects. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is rather to be accorded the widest scope consistent with the principles and novel features disclosed herein.

What is claimed is:

1. A stylus receiving tool, comprising:
a body portion having an anterior end, a posterior end opposite the anterior end, an exterior portion and an interior portion each extending from the anterior end to the posterior end; and
a receiver suitable for receiving a stylus, formed within the interior portion, and having an open portion at the anterior end.

2. The stylus receiving tool of claim 1, wherein the exterior portion comprises a pen size and shape.

3. The stylus receiving tool of claim 1, wherein the exterior portion comprises at least one rubberized grip.

4. The stylus receiving tool of claim 1, further comprising a pen clip extending outwardly from the exterior portion.

5. The stylus receiving tool of claim 1, further comprising at least one modifiable aspect suitable for modifying at least one of a size and a shape of the receiver.

6. The stylus receiving tool of claim 5, wherein the modifiable aspect comprises a roller having an actuator with a first portion extending outwardly from the exterior portion, and a second portion extending into the interior portion.

7. The stylus receiving tool of claim 5, wherein the modifiable aspect comprises at least one pressure nub extending within the interior portion.

8. The stylus receiving tool of claim 1, further comprising a function button receiver extending through the exterior portion into the interior portion.

9. The stylus receiving tool of claim 1, wherein the body portion comprises one of plastic, rubberized plastic, and rubber.

10. The stylus receiving tool of claim 1, wherein the body portion comprises at least one of a recyclable polycarbonate, acrylic and styrene.

11. The stylus receiving tool of claim 1, wherein the receiver at least substantially comprises a low-friction substance.

12. The stylus receiving tool of claim 1, wherein the posterior end comprises a storage compartment.

13. The stylus receiving tool of claim 1, further comprising a retractable writing utensil embedded in the exterior portion.

14. A method of providing a stylus receiving tool having a body portion with an anterior end, a posterior end opposite the anterior end, an exterior portion and an interior portion each extending from the anterior end to the posterior end, and a receiver suitable for receiving a stylus, formed within the interior portion, and having an open portion at the anterior end, the method comprising:
injection molding a polycarbonate into the body portion having the receiver therewithin; and
second injection molding at least one feature on the exterior portion.

15. The method of claim 14, wherein the feature comprises a rubberized grip.

16. The method of claim 14, wherein the injection molding further comprises providing a function button receiver extending from the exterior portion through to the interior portion.

17. The method of claim 14, further comprising:
attaching a pen clip to the exterior portion.

18. The method of claim 14, wherein the injection molding comprises molding to a pen size and shape.

19. The method of claim 14, further comprising:
inserting at least one modifiable aspect from the exterior portion into the receiver within the interior portion.

20. The method of claim 14, wherein the modifiable aspect comprises a roller having an actuator with a first portion extending outwardly from the exterior portion, and a second portion extending into the interior portion.
